(19) United States
(12) Patent Application Publication
(10) Pub. No.: US 2008/0078938 A1
(43) Pub. Date: Apr. 3, 2008

(54) X-RAY DETECTOR

(75) Inventors: Habib Vafi, Brookfield, WI (US); Emad M. Abu Tabanjeh, Franklin, WI (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/537,793

(22) Filed: Oct. 2, 2006

(51) Int. Cl. G01T 1/24

(52) U.S. Cl. 250/370.09

(57) ABSTRACT

A method of signal shielding in X-ray detectors and X-ray detectors using such a method are disclosed herein. In one embodiment, the X-ray detector has a set of detector elements placed on a substrate, and the shielding method includes providing a conductive shield above the data lines which carry the output signals of the detector elements. In another embodiment, the X-ray detector has a set of detector elements place on a substrate, and the method of signal shielding includes providing data lines on a flex layer that's bonded to a substrate, placing a conductive shield above the data lines, placing a flex shield on an interior surface of the flex layer, and conducting electromagnetic noise through the conductive shield and the flex shield.

### FIELD OF THE INVENTION

This invention generally relates to X-Ray detectors and more particularly to a method of signal shielding in X-ray detectors.

### BACKGROUND OF THE INVENTION

Solid state X-ray detectors are widely used as they offer better image quality at lower dose, better imaging speed and consistency. Detectors have been proposed to comprise a two dimensional array of 1,000 to 4,000 detector elements in each dimension (x,y). Each detector element consists of a photo sensor that detects and stores charge representative of an amount of radiation input to the detector element. Each detector element ultimately produces an electrical signal, which corresponds to the brightness of a picture element in the X-ray image projected onto the detector. The signal from each detector element is read out individually and digitized for further image processing, storage and display.

Prior art digital X-ray detectors may be generally constructed with a glass substrate having an interior surface and an exterior surface, with a number of detector elements arranged onto the exterior surface of the substrate. The arrangement creates an array of detector elements. Each detector element includes a scintillator and a photo sensor. A layer of absorptive material, such as black or dark colored vinyl, is located on the interior surface of the substrate. The absorptive material absorbs light and heat emitted from the detectors during X-ray detection. Supporting the material, a base or a frame that is grounded may be provided. Present day solid state photo sensors used in X-ray imaging are typically formed from amorphous silicon photodiodes.

Digital detectors provide high quality images at a lower dose than earlier analog detectors. They also provide faster imaging speed and higher consistency. Digital detectors are capable of storing the images and communicating the same.

However most of the digital detectors face artifact problems. Artifacts can be induced by many different external sources (mechanical and electrical), one of which is artifacts introduced by vibrations. There are several techniques present in various imaging systems as well as detectors to reduce the artifacts. Some of the well known methods include shielding. Some solutions include providing a detector cover capable of shielding the radiation from the external sources.

But most of the prior art solutions suggest sealing the substrate. This will enable the areas to be shielded, which are covered being inside the detector structure. Some of these areas are flex, which carries the data lines, to be bonded to the substrate. The area where the bonding occurs is very receptive to external noise. In some cases, this area is covered by the detector cover but still needs to be shielded separately, due to the higher chances of effects of noise. Any changes in electric field around data lines will cause interference that shows up as image artifacts. The amount of signals being dealt with in detectors is very small, and the changes in the signal are very small. Hence any changes in the external signal or affect will induce interference to the data line. There exists a need to shield the exposed areas or other areas, which are more prone to noise.

Thus it will be desirable to provide an improved shielding method for shielding the different areas of the detector. It would also be desirable to provide a method to reduce the artifacts in an X-ray detector.

### SUMMARY OF THE INVENTION

The above-mentioned shortcomings, disadvantages and problems are addressed herein which will be understood by reading and understanding the following specification.

In an embodiment the present invention provides a method of shielding electromagnetic radiation from an external source in an X-ray detector. The X-ray detector has a set of detector elements placed on a substrate. The method comprises providing a conductive shield above at least one data line, wherein the data lines carry output signals of the detector elements. The method further comprises providing a flex shield on an inner surface of a flex layer on which are provided the data lines. In an embodiment the conductive shield comprises an Indium Tin Oxide layer.

In one embodiment, a method of reducing artifacts in a solid state X-ray detector having a set of detector elements placed on a substrate by signal shielding is provided. The method comprises the steps of (a) providing a plurality of data lines on a flex layer; (b) placing a conductive shield above the data lines; (c) placing a flex shield on an interior surface of the flex layer, the flex layer being bonded to a substrate; and (d) conducting at least one portion of electromagnetic noise generated by external interface through the conductive shield and the flex shield. The method further comprises providing a substrate shield on an inner surface of the substrate.

In another embodiment, an X-ray detector with improved signal shielding is provided. The X-ray detector comprises (a) a substrate carrying a plurality of detector elements;(b) at least one data line provided for carrying the output signal of the detector elements; (c) a flex layer bonded to the substrate for carrying the data lines; and (d) a shield provided on the data lines, flex layer and the substrate, wherein the shield conducts at least a portion of electromagnetic noise generated by an external interface to ground.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of an X-ray detector incorporating a method of signal shielding as described in an embodiment of the invention;

FIG. 2 is a flowchart illustrating a method of signal shielding according to an embodiment of the invention;

FIG. 3 is a flowchart illustrating a method of reducing artifacts according to an embodiment of the invention;

FIGS. 4A and 4B illustrate a structural comparison of a detector without shielding and with a shielding as described in an embodiment of the invention; and

FIGS. 5A, 5B and 5C illustrate the effect of shielding in an X-ray detector in accordance with an embodiment of the invention.

### DETAILED DESCRIPTION OF THE INVENTION

In the following detailed description, reference is made to the accompanying drawings that form a part thereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

Disclosed herein is a shielding method for a digital detector for shielding the detector from electromagnetic noise generated due to any external interference. The shielding effectively shields data lines, which carry the output signals of the detector, the flex layer, which carries the data lines, and the substrate to which the flex layer is bonded. Thus the method offers three different shielding, which will reduce the effect of artifacts in the images significantly. The invention is applicable to any digital detectors including flat panel detectors. The method also suggests achieving the shielding by software as well as hardware means.

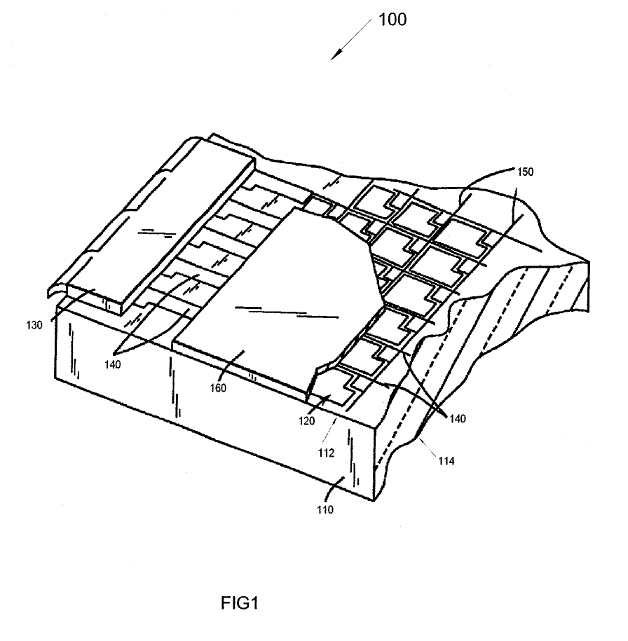

FIG. 1 is a schematic diagram of an X-ray detector incorporating a method of signal shielding as described in an embodiment of the invention. The detector 100 has a substrate 110, and at least one flex layer 130 bonded with the substrate 110. The substrate 110 has an outer surface 112 and an inner surface 114. The outer surface 112 of the substrate 110 is provided with an array of X-ray detector elements 120. Each detector element includes a scintillator and a photo sensor. The scintillator converts X-ray energy into light energy. The photo sensor, in turn, is sensitive to the visible light energy. A plurality of data lines 140 is provided for carrying the output signal of the detector elements. The output signal of each detector element is an electrical signal, corresponding to the brightness of a picture element in the X-ray image projected onto the detector. The data lines 140 are associated with the flex layer 130 and may be provided on any part of the flex layer 130. The data lines 140 are provided on both ends of the detector. The array of detector elements 120 is connected to an X-ray imaging system by scan lines 150 and data lines 140. The inner surface of the substrate 110 is connected to the base. The base is, at least in part, a good conductor of electricity, and may be connected to chassis ground, earth ground, or any other acceptable common. The substrate 110 is a poor dissipater of static charge. In an embodiment the substrate 110 is glass. An X-ray imaging system measures an amount of charge or current that recharges each detector element 120 to generate X-ray images. A protection layer 160 is provided above the array of detector elements 120 for shielding the substrate 110. The protective layer 160 should be hermetic and X-ray transmissive. The coefficient of thermal expansion of the protective layer should be compatible with that of the substrate 110. The protective layer may be made of Al-Graphite-Al cover sealed at edges with epoxy. Graphite epoxy layer is provided for stiffness with X-ray transparency and Aluminum layer is provided to reduce permeability to moisture.

In an embodiment of the invention a conductive shielding is provided over the data lines 140. This conductive shielding will act as a data line shield. As mentioned earlier, data lines 140 are provided for carrying output of array of the detector elements 120 and are placed on the flex layer 130. The conductive shielding incorporates a conductive layer of paint or any other coating material that is suitable to pass the signal generated from any external interference to ground. The conductive shield may be a conductive layer of any conducting material coated, laminated, glued, painted or bonded to the data line. Since the conductive shield is applied over the data line, it will maintain signal integrity and there will be no interference from the boundary signal. In an embodiment the conductive layer is an Indium Tin Oxide layer.

In another embodiment of the invention, a flex shield is provided on the flex layer 130. The flex layer 130 is bonded to the substrate 110. Anisotropically conductive film (ACF) bonding is used in bonding the flex layer 130 to the substrate 110. Since the area where the flex layer is bonded to the substrate is very receptive to noise, it is advantageous to shield it separately. To achieve the shielding of the flex layer a flex shield is provided on the interior surface of the flex layer 130. Providing the flex shield includes coating, painting a metal laminate or masking over the flex layer 130. The metal laminate is a copper or any similar conducting material. In an embodiment the metal laminate is a Copper layer.

In an embodiment a substrate shield is provided on the inner surface of the substrate 110. The substrate shield is formed using a conductive layer similar to the conductive shield placed above the data lines. In an example, the substrate shield is an Indium Tin Oxide layer. The substrate shield will act as an additional shield to protect the detector from the external interference.

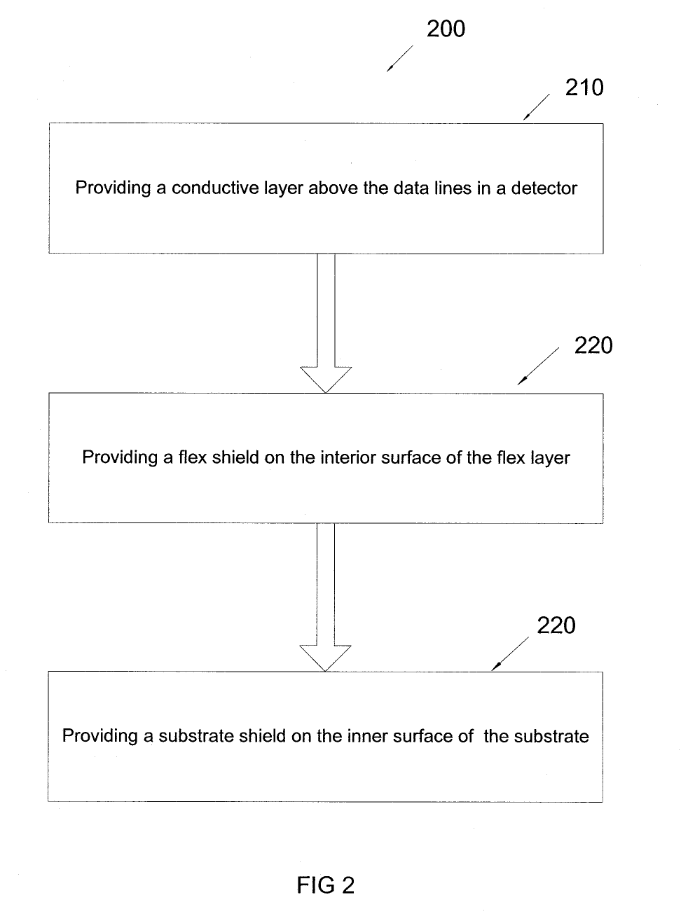

FIG. 2 is a high level flowchart illustrating a method of signal shielding according to an embodiment of the present invention. The method of signal shielding for reducing artifacts in an X-ray detector is described in 200. At block 210, a conductive shielding is provided above the data lines in a detector. The data lines carry the output of detector elements built on the detector. The conductive shielding can be provided using a conductive layer of paint or any other coating material that is suitable to be used to prevent any external interference on the data line carrying the pixel charges and passing that signal to ground. The conductive shield may include a conductive layer with a variety of substances, such as indium tin oxide, conductive paint, conductive foil, conductive mesh, conductive fibers, static dissipative paint, or any other conductive material. The various coating methods include automatic sprayer, squeegee, paint brusher, stencil screen, or sputter. The conductive shielding provides immunity to data lines from external electric field as well as magnetic field. Also the conductive shielding provides an increase in signal to noise ratio of the imaging system. The conductive shielding significantly improves data line noise and signal integrity from any interference source that might affect the data line in the Z-direction. At block 220, the flex layer is shielded by providing a flex shield on the interior surface of the flex layer. The flex shield comprises a coating or painting of a metal laminate over the interior surface of the flex layer. Providing the flex shield enhances the efficiency of the conductive layer and acts as an additional shielding. It helps eliminate signal coming from external electrical field and magnetic field. At block 230, a substrate shield is provided below or on the inner surface of the substrate. The substrate shield is a conductive layer, similar to the conductive shield placed above the data lines. The substrate shield is achieved by providing a conductive layer on the interior surface of the substrate. In an embodiment the substrate shield is Indium Tin Oxide layer.

In an embodiment the detector shielding is achieved by software subtraction. In this embodiment, the output signal of the detector with external interference and without external interference is determined. The difference between these two output signals yields an error signal. For shielding the detector or reducing the artifacts effects in the images the error signal is subtracted from the output signal of the detector. Thus the resulting output signal of the detector is free from the effects of external interferences.

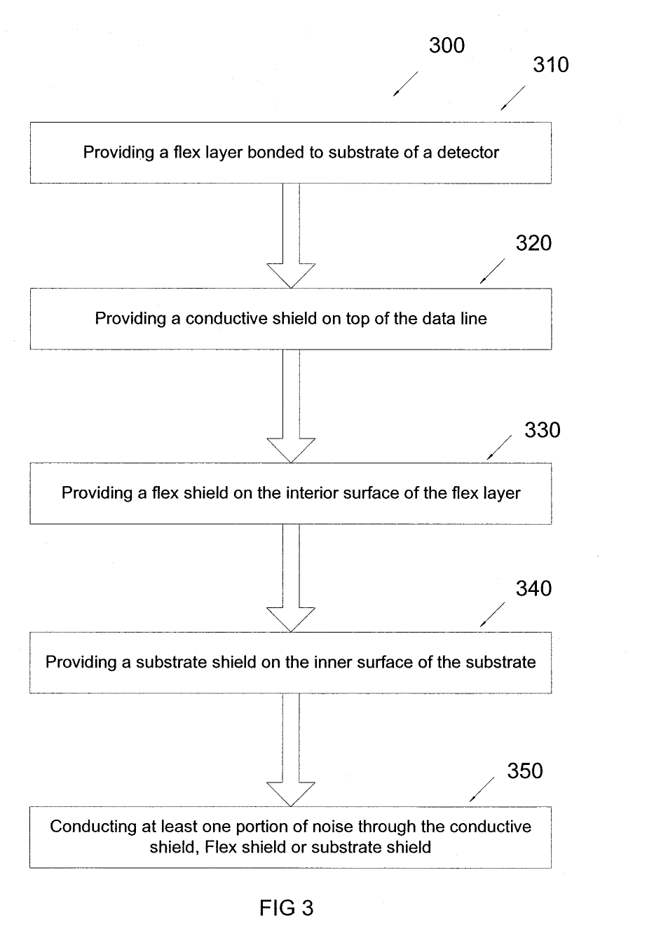

FIG. 3 is a flowchart illustrating a method 300 of reducing artifacts according to an embodiment of the present invention. At block 310, a flex layer is bonded to the substrate. In the detectors, detector elements are placed on the substrate. The flex layer is bonded to the substrate through Anisotropically conductive film (ACF) bonding. The data lines are provided on the flex layer for carrying output of the detector elements. At block 320, a conductive shield is provided above the data line. The conductive shield is a conductive layer with a conducting material coated, laminated, glued, painted or bonded to the data line. The conductive shield reduces data line noise and improves signal integrity from any interference source that might affect the data line in the Z-direction. At block 330, a flex shield is provided on the interior surface of the flex layer. The area where the flex layer is bonded to the substrate is very receptive to external noise and hence additional shielding isadvantageous. In certain instances the flex layer is bonded after shielding the detector and hence it need separate shielding. The flex layer is provided as a coating or lamination of a metal laminate on the interior surface of the flex layer. At block 340, a substrate shield is provided on the inner surface of the substrate. The substrate shield is a conductive layer placed on the inner surface of the substrate. The conductive layer is coated, laminated, glued, painted or bonded to the inner surface of the substrate. At block 350, at least a portion of the noise created by an external interface is conducted through the conductive shield, flex shield or the substrate shield and through the base of the detector to the ground.

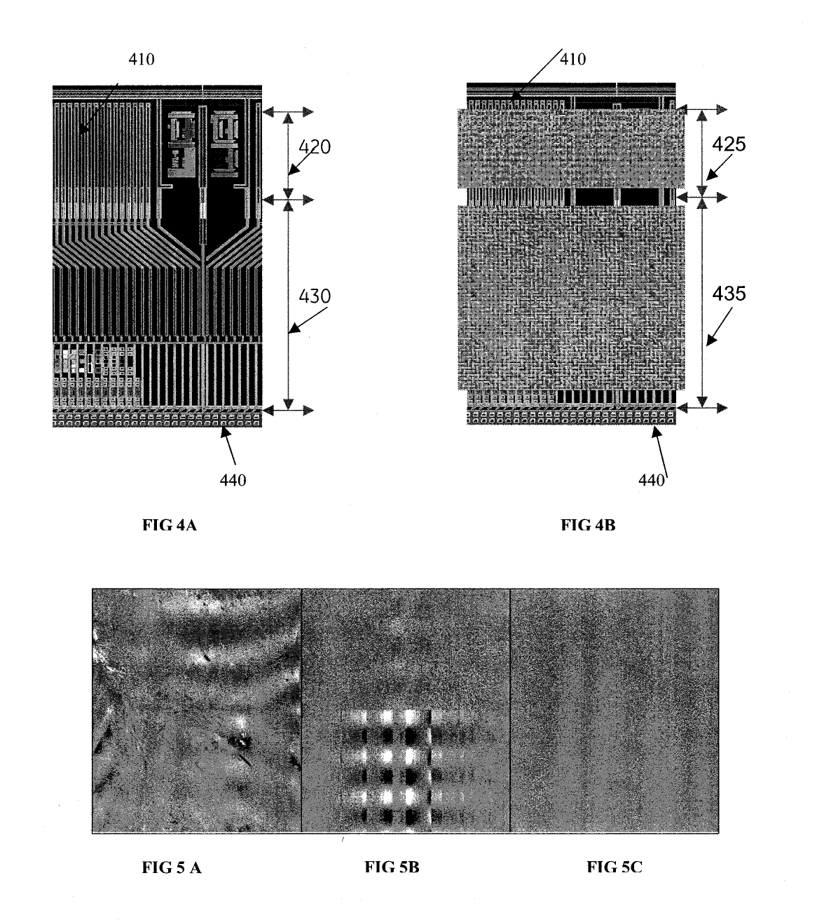

FIGS. 4A and 4B illustrate a comparison diagram of a detector without shielding and with a shielding as described in an embodiment of the invention. FIG. 4A illustrates a detector with out any shielding applied. The detector includes a plurality of detector elements 440 provided on the substrate. A flex layer bonded to the substrate incorporates a plurality of data lines 410 for carrying output of detector elements 440. FIG. 4A shows flex shield area 420 and data line shield area 430, where flex shielding and data shielding is required. FIG. 4B illustrates a detector with a flex shield 425 placed over the flex layer and a data line shield 435 placed over the data lines 410. The data line shield includes a conductive shield placed over the data line. The conductive shield is a conductive layer with a conducting material coated, laminated, glued, painted or bonded to the data line. The flex layer shield includes a coating or painting of a metal laminate over the flex layer.

FIGS. 5A, 5B and 5C illustrate the effect of shielding in an X-ray detector in accordance with an embodiment of the invention. The figures illustrate the improvement in artifacts reduction using the methods described above. FIG. 5A shows an image taken without any signal shielding. As seen the image is dominated with background fix artifacts. FIG. 5B is an image with a conductive shielding placed over the data line. As noticed there has been a reduction in the artifacts, fixed pattern artifacts have been eliminated. However strong row correlated artifacts remain. FIG. 5C shows an image with a conductive shielding placed over the data line and a flex shielding placed over the flex layer. The image obtained is artifacts free.

Some of the advantages of the invention include: 1) Providing immunity to data lines from EMC; 2) Providing more immunity to data lines from electrical fields; 3) Providing more immunity to data lines from magnetic fields; 4) Improving the signal to noise ratio; and 5) Providing signal robustness.

Various embodiments of this invention provide a method for shielding in an X-ray detector and an X-ray detector incorporating the shielding as herein described. The invention also provides a method for reducing artifacts in X-ray detectors. However, the embodiments are not limited to what is described herein and may be implemented in connection with any digital detector capable of detecting images including medical imaging, industrial imaging etc, but not limited to this.

While the invention has been described with reference to preferred embodiments, those skilled in the art will appreciate that certain substitutions, alaterations and omissions may be made to the embodiments without departing from the spirit of the invention. Accordingly, the foregoing description is meant to be exemplary only, and should not limit the scope of the invention as set forth in the following claims.

1-20. (canceled)

21. A method of shielding electromagnetic radiation from an external source in an X-ray detector including a plurality of detector elements placed on a substrate, a flex layer coupled to the substrate, and a plurality of data lines for carrying output signals from the plurality of detector elements to the flex layer, the method comprising: providing a data line shield above at least part of the plurality of data lines; and providing a flex shield above at least part of the flex layer.

22. The method of claim 21, wherein providing the data line shield includes providing a conductive layer above at least part of the plurality of data lines.

23. The method of claim 21, wherein providing the data line shield includes applying a conductive layer by coating, laminating, gluing, painting or bonding.

24. The method of claim 21, wherein applying the data line shield includes applying a layer of Indium Tin Oxide.

25. The method of claim 21, wherein providing the flex shield includes providing the flex shield on an interior surface of the flex layer.

26. The method of claim 21, wherein providing the flex shield includes providing a conductive layer above at least part of the flex layer.

27. The method of claim 21, wherein providing the flex shield includes applying a conductive layer by coating or painting a metal laminate over the flex layer.

28. The method of claim 21, wherein providing the flex shield includes applying a layer of copper.

29. The method of claim 21, further comprising providing a substrate shield on the substrate.

30. The method of claim 29, wherein providing the substrate shield includes providing the substrate shield on an inner surface of the substrate.

31. The method of claim 29, wherein providing the substrate shield includes placing a conductive shield above at least part of the plurality of data lines.

32. The method of claim 31, wherein providing the substrate shield includes providing a layer of Indium Tin Oxide.

33. An X-ray detector, comprising:
a substrate; a plurality of detector elements on the substrate;
a flex layer coupled to the substrate; and
a plurality of data lines for carrying output signals from the detector elements to the flex layer;
wherein the X-ray detector further comprises a data line shield for shielding the data lines and a flex shield for shielding the flex layer from electromagnetic interference.

34. The X-ray detector of claim 33, wherein the substrate is made of glass.

35. The X-ray detector of claim 33, wherein the flex layer includes a plurality of flex data lines for coupling the output signals from the plurality of data lines to an external system.

36. The X-ray detector of claim 33, wherein the plurality of data lines are also on the substrate.

37. The X-ray detector of claim 33, the data line shield includes a conductive layer for shielding the data lines from electromagnetic interference.

38. The X-ray detector of claim 33, wherein the data line shield includes a layer of Indium Tin Oxide.

39. The X-ray detector of claim 33, wherein the flex shield is on an interior surface of the flex layer.

40. The X-ray detector of claim 33, wherein the flex shield includes a conductive layer for shielding the flex layer from electromagnetic interference.

41. The X-ray detector of claim 33, wherein the flex shield includes a layer of copper.

42. The X-ray detector of claim 33, further comprising a substrate shield on the substrate.

43. An X-ray detector, comprising:
a substrate;
a plurality of detector elements on the substrate;
a flex layer coupled to the substrate; and
a plurality of data lines for carrying output signals from the detector elements to the flex layer;
wherein the X-ray detector further comprises a data line shield for shielding the data lines from electromagnetic interference, a flex shield for shielding the flex layer from electromagnetic interference, and a substrate shield for shielding the substrate from electromagnetic interference.

44. The X-ray detector of claim 43, wherein the data line shield, the flex shield and the substrate shield are each made of a conductive material.
